(19) United States
(12) Patent Application Publication
(10) Pub. No.: US 2008/0027796 A1
(43) Pub. Date: Jan. 31, 2008

(54) DISTRIBUTED REPUTATION-BASED RECOMMENDATION SYSTEM

(76) Inventor: Leonardo Weiss F Chaves, Karlsruhe (DE)

Correspondence Address: FISH & RICHARDSON, P.C., PO BOX 1022, MINNEAPOLIS, MN, 55440-1022, US

(21) Appl. No.: 11/461,166

(22) Filed: Jul. 31, 2006

(51) Int. Cl. G06Q 30/00

(52) U.S. Cl. 705/14

(57) ABSTRACT

A method for generating a recommendation to a customer includes detecting, in a first terminal that is part of a distributed terminal system in a commercial enterprise, an identifier for a first product. The identifier is detected in connection with a customer of the commercial enterprise, the first product being registered as belonging to a portion of the commercial enterprise assigned to the first terminal. Several other terminals in the distributed terminal system are prompted, after detecting the identifier, to generate recommendations intended for the customer. The generated recommendations are received, each generated by one of the prompted terminals using the detected identifier and a database local to that prompted terminal. At least one of the received recommendations are presented to the customer. Each presented recommendation is selected using a reputation value for the corresponding prompted terminal in a database local to the first terminal.

### TECHNICAL FIELD

This document relates to a distributed system for reputation-based recommendation.

### BACKGROUND

Businesses are constantly looking for ways to improve their sales strategies and to market their goods or services more effectively. One example is to advertise the goods and services or, more generally, to generate recommendations to customers that they should purchase a certain good or service. It is commonly believed that the efficiency of such recommendations can be improved by taking into account some known characteristic about the customer, such as the fact that the customer is currently planning to purchase a specific product or an analysis of the customer's past shopping habits.

Existing approaches in this area include the recommendation feature used by the online vendor called Amazon.com. There, a customer can be presented with recommendations for other products that the vendor believes the customer may be interested in. These recommendations are sometimes generated based on a recognition by the system that the current customer has placed a specific book in the electronic shopping cart, and thereafter accessing a database to identify products purchased by other customers who also bought the specific book.

### SUMMARY

The invention relates to a reputation-based recommendation. For example, it is described that a terminal in a commercial enterprise can select, from among received recommendations, the recommendation(s) to present to a customer based on reputations of the recommending terminals.

In a first general aspect, a computer-implemented method for generating a recommendation to a customer includes detecting, in a first terminal that is part of a distributed terminal system in a commercial enterprise, an identifier for a first product. The identifier is detected in connection with a customer of the commercial enterprise, the first product being registered as belonging to a portion of the commercial enterprise assigned to the first terminal. The method includes prompting several other terminals in the distributed terminal system after detecting the identifier. The terminals are prompted to generate recommendations intended for the customer about products that are registered as belonging to other portions of the commercial enterprise that are assigned to respective ones of the prompted terminals. The method includes receiving the generated recommendations from at least some of the prompted terminals. Each of the received recommendations is generated by one of the prompted terminals using the detected identifier and a database local to that prompted terminal. The method includes presenting at least one of the received recommendations to the customer. Each presented recommendation is selected from among the received recommendations using a reputation value for the corresponding prompted terminal that is stored in a database local to the first terminal.

Implementations can include any or all of the following features. The connection between the first product and the customer can be at least one selected from: the customer bringing the first product to the first terminal to perform a scanning, the customer placing the first product in a shopping cart, and the customer approaching a sales location where the first product is offered. The identifier can be detected using at least one technique selected from: RFID, automated visual inspection and barcode scanning. When the identifier is detected using the barcode scanning, the method can further include identifying the customer through at least one selected from: scanning a code on a shopping cart that the customer uses, and scanning a card that the customer presents to the first terminal. The presented recommendation can relate to a second product registered as belonging to a second portion of the commercial enterprise assigned to a second one of the prompted terminals. The method can further include accessing a sales record of the commercial enterprise to determine whether the customer purchased the second product subsequent to the presented recommendation. The method can further include modifying the reputation value for the second terminal, after accessing the sales record, to indicate whether the presented recommendation was successful, and distributing the modified reputation value in the distributed terminal system. When at least another one of the received recommendations is also presented to the customer together with the presented recommendation, the method can further include performing a similar modification of a reputation value for another one of the terminals that generated the other presented recommendation, and distributing also the modified reputation value for the other one of the terminals in the distributed terminal system. The reputation value for the second terminal can be used in selecting the presented recommendation is specific to the second product. The first terminal can have stored in its database several reputation values for the second terminal, and each of the reputation values can be associated with a respective one of several products that are registered as belonging to the second portion of the commercial enterprise. The second terminal can have stored in its database a record of multiple transactions that have taken place in the commercial enterprise, and each of the multiple transactions can involve at least one product that is registered as belonging to the second portion of the commercial enterprise, and wherein the second terminal generates the presented recommendation using the detected identifier and the record of multiple transactions. The prompted terminals can be selected, at the first terminal, from among all terminals of the distributed terminal system based on the identifier for the first product. The product can include a service that the customer can consume. The method can further include configuring any terminal in the distributed terminal system to be prohibited from generating a recommendation regarding a specific product. The presented recommendation can be presented to the customer on a display. The display can be located in a shopping cart used by the customer, the shopping cart communicating with the first terminal. The commercial enterprise can operate at several geographical locations, and at least some of the portions of the commercial enterprise can be located in different ones of the geographical locations.

In a second general aspect, a computer-implemented method for generating a recommendation to a customer includes detecting an RFID tag for a first product in a first terminal that is part of a wireless distributed terminal system in a retail establishment. The first product is proximate to a customer of the retail establishment, and is registered as belonging to a portion of the retail establishment assigned to the first terminal. The method includes prompting, after detecting the RFID tag, several other terminals in the wireless distributed terminal system to generate recommendations intended for the customer about products that are registered as belonging to other portions of the retail establishment that are assigned to respective ones of the prompted terminals. The method includes receiving the generated recommendations from at least some of the prompted terminals, each of the received recommendations being generated by one of the prompted terminals using information from the detected RFID tag and a database local to that prompted terminal. The method includes presenting at least one of the received recommendations to the customer on a display device at the first terminal. The presented recommendation relates to a second product registered as belonging to a second portion of the retail establishment assigned to a second terminal of the prompted terminals. The presented recommendation is selected from among the received recommendations using a reputation value for the second terminal stored in a database local to the first terminal. The method includes accessing a sales record of the retail establishment to determine whether the customer purchased the second product subsequent to the presented recommendation. The method includes modifying the reputation value for the second terminal, after accessing the sales record, to indicate whether the presented recommendation was successful. The method includes distributing the modified reputation value in the wireless distributed terminal system.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 schematically shows an example of a commercial enterprise with a distributed terminal system.

FIG. 2 shows an example of an architecture of a terminal that can be used in a distributed terminal system.

FIG. 3 shows a flow chart of an example of a method that can be performed in a commercial enterprise that has a distributed terminal system.

FIG. 4 is a block diagram of a computing system that can be used in connection with computer-implemented methods described in this document.

Like reference symbols in the various drawings indicate like elements.

### DETAILED DESCRIPTION

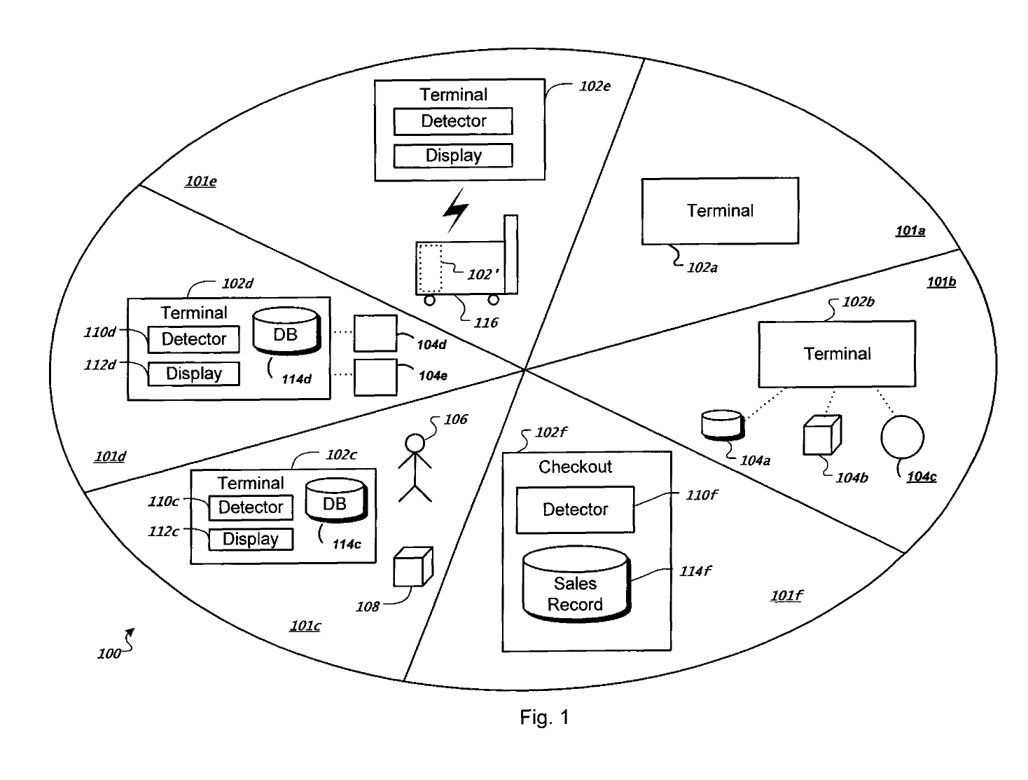

FIG. 1 schematically shows a commercial enterprise 100 that is divided in several jurisdictions 101. Each of the jurisdictions 101 corresponds to a portion of the commercial enterprise 100, for example such that when the enterprise 100 is a supermarket, the jurisdiction 101a is a particular department thereof. In another implementation, the commercial enterprise operates at several geographical locations. Some or all of the jurisdictions can then be located in different geographical locations.

The enterprise 100 has a distributed terminal system in the various jurisdictions 101. Particularly, each of the jurisdictions 101 is assigned to a terminal 102 that is part of the distributed terminal system, for example such that the terminal 102a is assigned to the jurisdiction 101a. In one implementation, the terminals 101 can be thought of as “smart terminals” for the respective jurisdictions, for example implemented as a touch-screen device with appropriate scanning capabilities. As such, customers can bring a product from any of the jurisdictions to one of the terminals for help or additional product information.

Products 104 in the enterprise 100 are registered as belonging to specific ones of the jurisdictions 101, for example such that products 104a-c belong to the jurisdiction 101b. The jurisdiction 101b is assigned to the terminal 102b, and this terminal monitors the products 104a-c that belong to this jurisdiction. Thus, each of the terminals 102 has a specified collection of products within its jurisdiction, and it will be described below that each of the terminals can send recommendations regarding its own products to other terminals, which recommendations the receiving terminal selectively presents to a customer based on the sending terminal's reputation. For example, any of the terminals 102 can display an advertisement for a product in any other jurisdiction.

Assume, for example, that a customer 106 is currently in the jurisdiction 101c and has taken a product 108 from one of the shelves there. The product 108 is equipped with an RFID tag that the terminal 102c detects with a detector 110a. For example, the customer is looking for information about the product 108 such as its price or manufacturer, and brings it to the terminal 102c which is designed to present such information upon detecting the particular product. Thus, upon the terminal 102c detecting an identifier for the product 108, the terminal retrieves the relevant information and presents it to the customer on a display 112a. But the terminal 102c can also present a recommendation to the customer about another product, and this recommendation can be tailored based on the particular product that the customer has selected, as will now be described.

Upon detecting the identifier for the product 108, the terminal 102c asks some or all of the other terminals 102 to recommend some of their own products based on the product that the customer has selected. This can be considered an implementation of a “cross-selling” strategy. Such a strategy can be based on the assumption that a customer who is interested in product A has a higher than average likelihood of also being interested in another specific product B. Thus, knowing that the customer has picked up product A, the cross-selling strategy can identify product B as being the correct one to advertise. These associations between products can be determined using various well-known algorithms that take into account predefined correlations between products. Such algorithms or correlations can be obtained by performing data mining in large volumes of relevant sales data, by analyzing customer behavior, or by statistically tracking purchasing trends in relevant industries, to name a few examples. Thus, the terminal 102c prompts some or all of the other terminals 102 to generate such recommendations based on the identity of the product 108. Such prompting can be done through a wireless connection in the distributed terminal system. In some implementations, the terminal 102c sends the prompt to fewer than all of the other terminals 102 based on a filtering done using the detected identifier for the product.

The prompted terminals can recommend one or more of the products within their respective jurisdictions. For example, in the jurisdiction 101d that is assigned to the terminal 102d, there are two products 104d and 104e in this example. Thus, upon the terminal 102d being prompted, it will determine whether it should recommend either of the products 104d and 104e, or both of them, or whether it should not make any recommendation at all in the current situation. In some implementations, some or all of the jurisdictions 101 can include many more products than shown here, for example many thousands of products or more.

The terminals 102 in the distributed terminal system all have their own local databases 114. Each of the local databases can have stored therein sales records for use in making recommendations. Each terminal that is prompted for a recommendation generates its recommendation using the detected identifier and the local database. Moreover, because the enterprise has a distributed terminal system, each of the terminals can use its own analytic approach in processing the sales records.

Here, the terminal 102c has a database 114c and the terminal 102d has a database 114d. The database 114d can for example include sales records for previous transactions in the enterprise 100 that involved at least one of the products 104d and 104e. The terminal 102d analyzes these sales records in the local database 114d, for example to determine whether there is a strong correlation between sales of the product 108 and either of the products 104d and 104e. Assume that the outcome of this analysis is that only the product 104d should be recommended. The terminal 102d then forwards this recommendation to the terminal 102c, which was the one that requested it.

Some or all of the prompted terminals forward recommendations for cross-selling advertisements to the requesting terminal 102c. However, there can be several reasons why one of the prompted terminals does not respond. First, the non-responding terminal could have determined that it did not have a sufficiently reliable basis for recommending any of its products based on the current product 108. In other words, the non-responding terminal's own products did not have enough correlation with the product 108 to make a cross-selling recommendation. As will be described below, every terminal's reputation in the distributed terminal system is affected by whether it makes successful or unsuccessful recommendations, so the terminals are configured to make recommendations only when they determine, using their local database and their particular analytic approach, that the probability of a successful cross-selling meets a predefined criterion. As used herein, a successful recommendation means that the customer to whom the recommendation is made subsequently buys the recommended product within a predefined time limit, such as during the same day. Similarly, an unsuccessful recommendation means that the customer to whom the recommendation was made does not subsequently buy the recommended product within the same or a different predefined time limit.

Second, there could have been a transmission error. The prompt from the terminal 102c could have failed to reach one or more of the other terminals 102, for example due to a faulty wireless connection in the distributed terminal system. Similarly, a recommendation from one of the prompted terminals can fail to reach the terminal 102c.

Third, the non-responding terminal could have been too busy to generate and transmit the recommendation within a prescribed time limit, perhaps because the non-responding terminal was busy gathering and processing recommendations for presenting an advertisement on its own display 112. The time limit for responding can be set based on the amount of time that the customer can be expected to keep watching the display, so that there is enough time to present the advertisement before the customer leaves.

Thus, the terminal 102c receives recommendations from one or more of the other terminals in response to its prompting. The terminal 102c will now determine which one(s) of the recommendations to display. For this, the terminal uses a reputation value associated with each of the prompted terminals. The reputation value is set based on each terminal's track record regarding successful and unsuccessful recommendations. For example, the reputation value can be an integer variable that is incremented for every successful recommendation and decremented (by the same or a different amount) for every unsuccessful recommendation. Other types of reputation values can be used.

The terminal 102c looks at the reputation values for all of the terminals that responded with recommendations. The terminal 102c then selects at least one of the received recommendations using the respective reputation values. For example, the terminal selects only the recommendation from the terminal with the highest reputation value, or strikes the terminals whose reputations are in the bottom 33%, or it can weigh the reputation values with the products being recommended. If all the received recommendations come from terminals with sufficient reputation, they can all be presented.

One example of weighing in the recommended product is to maintain multiple reputation values for each terminal corresponding to the different products within its jurisdiction. For example, the terminal 102d can have separate reputation values for the products 104d and 104e. This can reflect a situation where the terminal 102d is better at correctly predicting a cross-selling opportunity for the product 104d than for the product 104e. A benefit of such separate reputation values, then, is that the “good” recommendations regarding the product 104d are not unduly tainted by the terminal's “bad” reputation in trying to cross-sell the product 104e. Other ways of choosing between the received recommendations with the reputation values can be used.

Having selected at least one of the received recommendations, the terminal 102c presents the recommendation on the display 112c. If the customer scanned the product 108 at the terminal 102c to see the price or other product information, the selected recommendation(s) can be presented in connection with that information. For example, the recommendation can be displayed as an advertisement on part of the screen. Optionally, the advertisement informs the customer about the location in the enterprise where the product 104d can be found (i.e., the jurisdiction 101d). The jurisdiction 101d can be in the same geographical location as the jurisdiction 102c, such as in the same store, or in a different geographical location, such as in another city.

The success or failure of each recommendation is determined based on whether the customer buys the recommended product. Assume that the customer here sees the advertisement on the display 112c, and decides to follow the recommendation and buy the product 104d. The customer then goes to the jurisdiction 101d and picks up the product 102d. When the customer is done shopping, the customer brings the product(s) to a checkout jurisdiction 101f. There is located one or more checkout terminals 102f, such as a computer-based cash register. The checkout terminals 102f are part of the distributed terminal system and register the product(s) purchased by each customer. For example, the RFID tag on the product can be detected by a detector 110f in the terminal 102f. Here, the detector 110f detects the product 104d as well as any other products that the customer is buying. The sales information is stored in a sales record database 114f.

The sales records from the checkout terminal are distributed to the terminals 102 for use in making new recommendations and also in evaluating the success of earlier recommendations. Particularly, the sales record regarding the product 104d reaches the terminal 102c. The terminal 102c knows that the particular product item that was sold is the one that was picked up as a result of the recommendation. There are several ways that the terminal 102c can gain this knowledge. First, if the customer also purchased the product 108, then the RFID tag for the product 108 was likewise detected by the detector 110f and stored in the sales record. The terminal 102c registered the RFID tag of the product 108 when the customer approached the terminal. Thus, the RFID information from the sales record is matched with the information in the database 114c regarding which product the customer brought to the terminal.

Second, even if the customer did not ultimately buy the product 108, but temporarily brought that product over to the jurisdiction 101d when picking up the product 104d, the detector 110d could have registered the RFID tag of the product 108 at that point. The terminals 102 can help each other correlate relevant sales information by sharing this information in the distributed terminal system.

Third, the customer could have been using a shopping cart 116 that is equipped with an in-cart terminal 102′ that is also part of the distributed terminal system. The terminal 102′ can have a detector 110 and a display 112 similar to the other terminals 102. Moreover, the shopping cart can make its presence known to any of the other terminals 102 when visiting their respective jurisdictions, for example through wireless communication. Thus, at the checkout terminal 102f the cart 116 is detected together with the purchase of the product 104a and this information can be used to confirm that the recommendation was successful.

Fourth, the customer can be identified by reading a customer card that the customer presents to the terminal. This can be a card issued as part of a customer rewards initiative such as a frequent flyer program or a shopping club. Each of the terminals 102 can be equipped with a reader capable of scanning the card. The customer can be encourage to present the card at the reader by a promise of a predefined benefit, such as added points in the program or a discount on the presented good(s). When the customer later presents the card at the checkout terminal 102f, or a credit card that the distributed terminal system recognizes as associated with the customer in the rewards program, the connection between the product detection at the terminal 102c and the subsequent product purchase at the checkout terminal 102f can be made.

Another way that the terminals 102 can detect products is by automated visual inspection. For example, the detector 110c can be equipped with a video camera, an image processor and appropriate software for recognizing the product 108 when the customer approaches the terminal. To have the product detected, the customer can bring it proximate the camera similarly to the situation when a barcode or RFID tag is to be detected. The terminal 102c can have a library of images in the database 114c of the products that are within its jurisdiction, and can identify the product 108 based on digital image-matching against the database.

The shopping cart 116 can be instrumental in matching up the sold and recommended products also in a non-RFID implementation. For example, assume that the product 108 is provided with a barcode label and that the detectors 110 are barcode scanners. Unlike RFID tags, barcode labels typically are not unique to the particular item that the customer picks up at the store, but rather are common for all items of a specific product type or model. In such implementations, the cart 116 can be provided with a unique barcode that is registered by the detector 110a when the customer approaches the terminal 102c. This barcode number can then be stored in the database 114d as being associated with the recommendation. At the checkout terminal 102f, the detector 110f similarly can register the unique barcode of the shopping cart and store this information together with the sales record for the product 104d in the sales record 114f. Thus, the terminal 102c can determine using the sales record whether the recommendation was successful.

The display of the terminal 102′ can also be used for presenting the selected recommendation(s) to the customer. Particularly, if the customer places the product 108 in the cart 116, the terminal 102′ can notify the corresponding terminal for that jurisdiction that the product has been picked up, and that terminal can in turn prompt the other terminals to initiate the recommendation-gathering process. The notified terminal can then choose between the received recommendations and forward the selected one(s) wirelessly to the cart for presentation on its display. Alternatively, the cart obtains all of the recommendations and makes its own decision using the respective reputation values.

The post-recommendation processing of the reputation value can be performed by the terminal that presented the recommendation. Assume now that the customer 106 purchases the product 104d after the recommendation is presented at the terminal 102c. The terminal 102c accesses the sales record 114f and matches the sale of the product 104d with the recommendation received from the terminal 102d. The terminal 102c modifies the reputation value for the terminal 102d to indicate that the recommendation was successful. Similarly, assume that terminal 102c also presented a recommendation for the product 104a generated by the terminal 102b, but that the customer did not buy this product within a predefined time limit. This means that the latter recommendation was unsuccessful, and the terminal 102c can likewise modify the reputation value for the terminal 102b accordingly. The terminal 102c can then distribute the modified reputation value(s) to others of the terminals 102 in the distributed terminal system, for storage in their respective local databases 114. This helps the other terminals make decisions about which recommendation(s) to present.

In some implementations, any of the terminals 102 can use the reputation values stored in their local database also to filter out one or more other terminals before asking for recommendations. That is, the terminal can direct its prompt, for example over a wireless communication link in the distributed terminal system, to only some of the terminals that have the best reputation values. As noted above, the reputation values can be product-specific for any or all of the terminals.

It is possible that some products in the commercial enterprise 100 (e.g., a store) are “big selling items” such that many or all of the customers buy these items when visiting. In other words, these items are in effect the attraction that lures many of the customers to the enterprise and can therefore be considered relatively easy to sell. If the terminal for the jurisdiction where the big selling items are located is allowed to issue recommendations for these items, it is likely that such recommendations will often be successful. As such, the terminal for these items will likely gain a very good reputation in the distributed terminal system. However, in situations such as these it can be suspected that the frequent sales of the big selling items is not only a result of the frequent recommendations (e.g., advertisements) generated by the responsible terminal, but rather also a result of these products' inherent ability to attract customers to the store. The distributed terminal system can therefore be configured such that one or more of the terminals 102 is prohibited from generating a recommendation for a specific product, for example the big selling items in this example.

In the above examples, the products 104 and 108 have been described as tangible items that the customer can move around, for example with the use of the cart 116. The distributed terminal system can also be used, however, with intangible assets such as services. For example, assume that the commercial enterprise 100 is an amusement park and that the products 104 and 108 are attractions that the customer 106 (i.e., a visitor) can ride. Upon the customer visiting the jurisdiction 101c to enjoy the attraction(s) available there, the customer's wristband can be automatically read by a scanner in the terminal 102c. Based on a process of polling the other terminals in the distributed terminal system, analogous to the examples above, the terminal 102c can present a recommendation to the visitor for another attraction in the amusement park. If the customer's wristband is later scanned at that recommended attraction, the recommending terminal can gain a corresponding improvement in reputation. Thus, as used herein, the term product can also mean a service that the customer can consume.

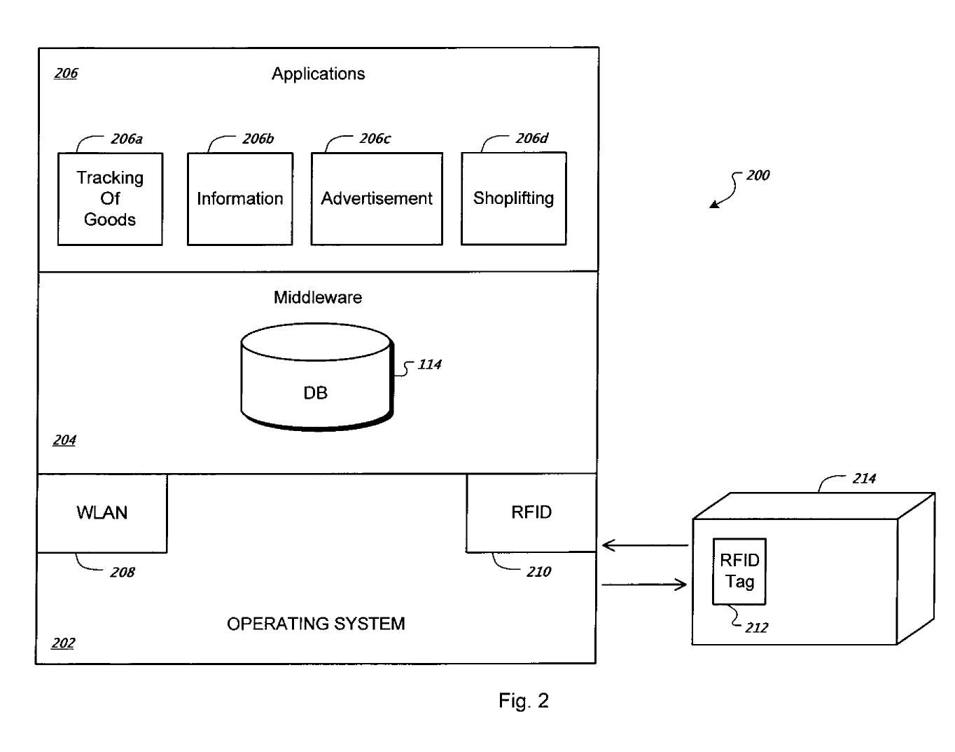

There will now be described an example of an architecture for the terminals 102. FIG. 2 shows an architecture 200 that includes an operating system layer 202, a middleware layer 204 and an applications layer 206. The operating system is responsible for the overall operation and functionality of the terminal. The terminal can be implemented to work with any existing operating system, for example those commonly used in PC or Mac computers, handheld devices, GPS devices, or cellular phones. Particularly, the operating system here is configured with a wireless local area network (WLAN) unit 208 and an RFID unit 210. For example, the WLAN unit 208 can be a wireless network card connected to a laptop-type motherboard, and the RFID unit can be connected as a peripheral unit, for example through any auxiliary bus or port of the motherboard. The RFID unit interacts, as is well known, with one or more RFID tags 212 that can be applied to an object 214 such as a product or a shopping cart. The RFID unit and the RFID tag(s) can be configured for active or passive RFID detection, or both.

The operating system can also provide for suitable output from the terminal. For example, the operating system can support any of the displays 112, such as a touch-screen display that the customer can interact with. In some implementations, other types of output such as audio or printing can be provided.

The applications layer 206 includes one or more applications that the terminal can execute to perform specific operations. Here, a first application 206a is responsible for tracking of goods, for example to track the products that are currently within the terminal's jurisdiction. Thus, when the terminal detects a particular product, for example using the RFID unit 210, the application 206a can register the detected product as being present in the jurisdiction. A second application 206b is responsible for obtaining and presenting product information. Thus, when the terminal detects a particular product the application 206b can obtain information for that product, such as the price and the manufacturer's name, from the local database and present it to the customer on the display. A third application 206c is responsible for advertisement and other recommendations. Thus, when the terminal detects a particular product the application 206c can prompt the other terminals in the distributed terminal system for recommendations based on that product. A fourth application 206d is responsible for shoplifting prevention. Thus, when the terminal detects the removal of a particular product and there is not a corresponding sales transaction for that product in the checkout terminal, the application 206d can register that product as being stolen. If the missing product has merely been relocated to another jurisdiction, the terminal for that jurisdiction will notify the application 206a about this relocation.

The middleware layer 204 connects the applications and operating system together for the operation of the terminal. For example, the middleware can provide an interface for any of the applications to the WLAN or RFID units. Also, the middleware can manage the local database 114 for the terminal and be responsible for the sharing of relevant information in the distributed terminal system.

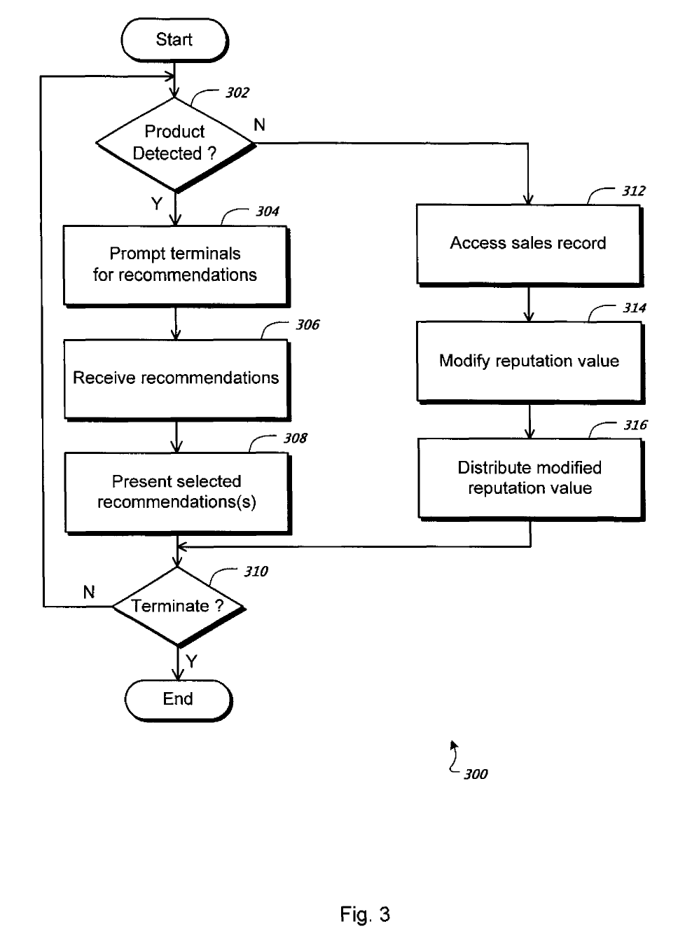

FIG. 3 is a flow chart for a method 300 that can be performed in managing products in the distributed terminal system. The method 300 can be performed by a processor executing instructions in a computer program product. The method 300 begins in step 302 with a determination whether a product has been detected. For example, the terminal 102c can monitor whether the detector 110c has registered a product. If no product has currently been detected, the reputation value processing can be performed, as will be described below.

If an identifier for a product is detected in step 302, a recommendation procedure will be initiated. For example, the recommendation procedure is initiated upon the customer 106 bringing the product 108 to the terminal 102c. In step 304, several other terminals in the distributed terminal system are prompted. The terminals are prompted to generate recommendations intended for the customer about products that are registered as belonging to other portions of the commercial enterprise that are assigned to those several other terminals. For example, the terminal 102c can prompt the other terminals 102a-b and 102d-c for recommendations.

In step 306, the generated recommendations are received from at least some of the prompted terminals. Each of the received recommendations is generated by one of the prompted terminals using the detected identifier and a database local to that prompted terminal. For example, the terminal 102d probes its database with the identifier for the product 108 and thereafter generates a recommendation for the product 104d.

In step 308, at least one of the received recommendations is presented to the customer. Each presented recommendation is selected from among the received recommendations using a reputation value for the corresponding prompted terminal. The reputation value is obtained from the local database. For example, the terminal 102c can receive recommendations from each of the terminals 102a-b and 102d-e in response to the prompting, and can decide to present the recommendations from the terminals 102b and 102d based on their respective reputation values that the terminal 102c has in the database 114c.

In step 310, it is determined whether to terminate or return to step 302. For example, the method 300 can be executed continuously during the business hours of the commercial enterprise 100 and can be terminated when no further products are being detected and all reputation value processing is complete.

Upon step 302 being executed, assume that no product is currently detected. Step 312 is then performed in which a sales record of the commercial enterprise is accessed to determine whether the customer purchased the recommended product(s) after the recommendation(s). For example, the terminal 102c can access the sales record in the database 110f and determine whether the customer 106 purchased the products 104d or 104a. In some implementations, the sales records for each particular product are automatically distributed to the local database of the responsible terminal. In such implementations, the terminal could access the database 110d to see whether the product 104d was sold, and the database 110a to see if the product 104a was sold. Alternatively, the responsible terminal can automatically forward relevant sales records to terminals that it has made a recommendation to.

In step 314, the reputation value for any terminal whose recommendation was presented to the customer is modified, to indicate whether the recommendation was successful. For example, the terminal 102c can modify the reputation values for the terminals 102b and 102d.

In step 316, the modified reputation value(s) is distributed in the distributed terminal system. For example, the terminal 102c can share the modified reputation values with the terminals 102a-b and 102d-e. Thereafter, it is determined, in step 310, whether to terminate or return to step 302.

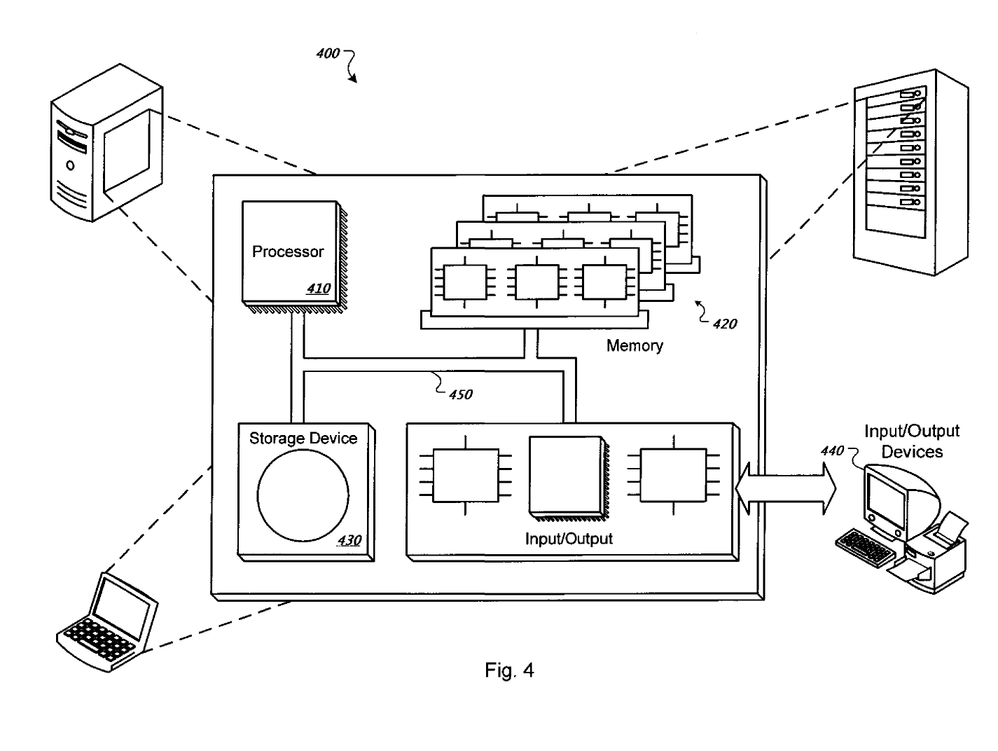

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for generating a recommendation to a customer, the method comprising:
detecting, in a first terminal that is part of a distributed terminal system in a commercial enterprise, an identifier for a first product in connection with a customer of the commercial enterprise, the first product being registered as belonging to a portion of the commercial enterprise assigned to the first terminal;
prompting, after detecting the identifier, several other terminals in the distributed terminal system to generate recommendations intended for the customer about products that are registered as belonging to other portions of the commercial enterprise that are assigned to respective ones of the prompted terminals;
receiving the generated recommendations from at least some of the prompted terminals, each of the received recommendations being generated by one of the prompted terminals using the detected identifier and a database local to that prompted terminal; and
presenting at least one of the received recommendations to the customer, each presented recommendation being selected from among the received recommendations using a reputation value for the corresponding prompted terminal that is stored in a database local to the first terminal.

2. The computer-implemented method of claim 1, wherein the connection between the first product and the customer is at least one selected from: the customer bringing the first product to the first terminal to perform a scanning, the customer placing the first product in a shopping cart, and the customer approaching a sales location where the first product is offered.

3. The computer-implemented method of claim 1, wherein the identifier is detected using at least one technique selected from: RFID, automated visual inspection and barcode scanning.

4. The computer-implemented method of claim 3, wherein the identifier is detected using the barcode scanning, further comprising identifying the customer through at least one selected from: scanning a code on a shopping cart that the customer uses, and scanning a card that the customer presents to the first terminal.

5. The computer-implemented method of claim 1, wherein the presented recommendation relates to a second product registered as belonging to a second portion of the commercial enterprise assigned to a second one of the prompted terminals.

6. The computer-implemented method of claim 5, further comprising accessing a sales record of the commercial enterprise to determine whether the customer purchased the second product subsequent to the presented recommendation.

7. The computer-implemented method of claim 6, further comprising modifying the reputation value for the second terminal, after accessing the sales record, to indicate whether the presented recommendation was successful, and distributing the modified reputation value in the distributed terminal system.

8. The computer-implemented method of claim 7, wherein at least another one of the received recommendations is also presented to the customer together with the presented recommendation, further comprising performing a similar modification of a reputation value for another one of the terminals that generated the other presented recommendation, and distributing also the modified reputation value for the other one of the terminals in the distributed terminal system.

9. The computer-implemented method of claim 5, wherein the reputation value for the second terminal used in selecting the presented recommendation is specific to the second product.

10. The computer-implemented method of claim 9, wherein the first terminal has stored in its database several reputation values for the second terminal, each of the reputation values being associated with a respective one of several products that are registered as belonging to the second portion of the commercial enterprise.

11. The computer-implemented method of claim 5, wherein the second terminal has stored in its database a record of multiple transactions that have taken place in the commercial enterprise, each of the multiple transactions involving at least one product that is registered as belonging to the second portion of the commercial enterprise, and wherein the second terminal generates the presented recommendation using the detected identifier and the record of multiple transactions.

12. The computer-implemented method of claim 1, wherein the prompted terminals are selected, at the first terminal, from among all terminals of the distributed terminal system based on the identifier for the first product.

13. The computer-implemented method of claim 1, wherein the product comprises a service that the customer can consume.

14. The computer-implemented method of claim 1, further comprising configuring any terminal in the distributed terminal system to be prohibited from generating a recommendation regarding a specific product.

15. The computer-implemented method of claim 1, wherein the presented recommendation is presented to the customer on a display.

16. The computer-implemented method of claim 15, wherein the display is located in a shopping cart used by the customer, the shopping cart communicating with the first terminal.

17. The computer-implemented method of claim 1, wherein the commercial enterprise operates at several geographical locations, and wherein at least some of the portions of the commercial enterprise are located in different ones of the geographical locations.

18. A computer program product tangibly embodied in an information carrier and comprising instructions that when executed by a processor perform a method for generating a recommendation to a customer, the method comprising:
detecting, in a first terminal that is part of a distributed terminal system in a commercial enterprise, an identifier for a first product in connection with a customer of the commercial enterprise, the first product being registered as belonging to a portion of the commercial enterprise assigned to the first terminal;
prompting, after detecting the identifier, several other terminals in the distributed terminal system to generate recommendations intended for the customer about products that are registered as belonging to other portions of the commercial enterprise that are assigned to respective ones of the prompted terminals;
receiving the generated recommendations from at least some of the prompted terminals, each of the received recommendations being generated by one of the prompted terminals using the detected identifier and a database local to that prompted terminal; and
presenting at least one of the received recommendations to the customer, each presented recommendation being selected from among the received recommendations using a reputation value for the corresponding prompted terminal that is stored in a database local to the first terminal.

19. A computer-implemented method for generating a recommendation to a customer, the method comprising:
detecting, in a first terminal that is part of a wireless distributed terminal system in a retail establishment, an RFID tag for a first product proximate to a customer of the retail establishment, the first product being registered as belonging to a portion of the retail establishment assigned to the first terminal;
prompting, after detecting the RFID tag, several other terminals in the wireless distributed terminal system to generate recommendations intended for the customer about products that are registered as belonging to other portions of the retail establishment that are assigned to respective ones of the prompted terminals;
receiving the generated recommendations from at least some of the prompted terminals, each of the received recommendations being generated by one of the prompted terminals using information from the detected RFID tag and a database local to that prompted terminal;
presenting at least one of the received recommendations to the customer on a display device at the first terminal, the presented recommendation relating to a second product registered as belonging to a second portion of the retail establishment assigned to a second terminal of the prompted terminals, the presented recommendation being selected from among the received recommendations using a reputation value for the second terminal stored in a database local to the first terminal;
accessing a sales record of the retail establishment to determine whether the customer purchased the second product subsequent to the presented recommendation;
modifying the reputation value for the second terminal, after accessing the sales record, to indicate whether the presented recommendation was successful; and
distributing the modified reputation value in the wireless distributed terminal system.
